(19) United States
(12) Patent Application Publication
(10) Pub. No.: US 2010/0190126 A1
(43) Pub. Date: Jul. 29, 2010

(54) NASAL AND MAXILLARY GROWTH ENHANCER

(76) Inventor: Hyo-Sang Park, Daegu (KR)

Correspondence Address: NIXON PEABODY, LLP, 401 9TH STREET, NW, SUITE 900, WASHINGTON, DC, 20004-2128, US

(21) Appl. No.: 12/358,266

(22) Filed: Jan. 23, 2009

(51) Int. Cl. A61C 7/06

(52) U.S. Cl. 433/5

(57) ABSTRACT

A nasal and maxillary growth enhancer includes: a nose retracting member connected with a face mask, which is a maxillary protraction appliance, to be provided with an anterior traction power, the nose retracting member including: a nose grip having elastic arms branched from the top of a connector into two parts and inclined inwardly and nasal septum holders respectively formed on ends of the elastic arms to hold the nasal septum (located on the centerline between the two nostrils) after being inserted into the nostrils; the connector adapted to support the nose grip and a hook; and the hook formed on the bottom of the connector. The nasal and maxillary growth enhancer can correct the Class III malocclusion, which is called a ‘jutting chin’, and provide an effect of deformity correction by promoting the nasal and labial growth without undergoing a plastic surgery.

### BACKGROUND OF THE INVENTION

1. Field of the Invention

The present invention relates to a nasal and maxillary growth enhancer, and more particularly, to a nasal and maxillary growth enhancer, which can enhance the correct efficiency and provide an effect of deformity correction since it achieves correction of the Class III malocclusion and enhancement of nasal growth at the same time when the malocclusion is corrected with a face mask.

2. Background Art

In general, in dental surgery, malocclusion is divided into skeletal Class I, II and III malocclusions.

The Class I malocclusion means that teeth are aligned not uniformly but crookedly or there is a gap between the teeth due to a wide interval between the teeth while the upper chin and the lower chin are in normal conditions.

The Class II malocclusion means that the upper chin protrudes more forwardly than the lower chin, and in this instance, the upper chin grew excessively or the lower chin was poor in growth.

The Class III malocclusion means the lower chin protrudes forwardly more than the upper chin, namely, a jutting chin.

The malocclusion causes a bad appearance and a bad pronunciation since a patient cannot pronounce correctly, and particularly, in case of children, they may meet with an obstacle in growth of a maxillary bone or surrounding tissues, and hence, the malocclusion must be treated timely.

In the present invention, a device for correcting the Class III malocclusion, frequently called a ‘jutting chin’, will be described.

A maxillary protraction appliance (MPA), which is generally used for correction of the Class III malocclusion, is a face mask, and the face mask is divided into various kinds, for instance, a maxillary protraction appliance having a hook formed on a chin cap, a Delaire type face mask, a Tubingen's modified Delaire type face mask, a Petit face mask as shown in FIGS. 1a to 1d.

Furthermore, in order to correct the Class III malocclusion, a maxillary expander is used together with the face mask, and the maxillary expander is divided into various kinds, for instance, an adhesive expander, a band-type expander as shown in FIGS. 2a and 2b.

After the maxillary protraction appliance is worn on the patient, a hook of the maxillary expander, which is put in the oral cavity, is connected to the maxillary protraction appliance with an elastic member, such as a rubber ring, and then, the maxillary bone is retracted forwardly to thereby correct the Class III malocclusion, called the ‘jutting chin’.

However, the correction treatment of the Class III malocclusion has a limitation in chin correction since the lips and the nose are not drawn together with the maxillary bone while the maxillary bone is retracted forwardly to draw the upper chin forward.

Accordingly, the correction treatment of the Class III malocclusion has a problem in that it results in lots of time and expenses since the patient may additionally undergo a nasal surgery by reason of the beauty after the correction treatment of the Class III malocclusion.

### SUMMARY OF THE INVENTION

Accordingly, the present invention has been made to solve the above-mentioned problems occurring in the prior arts, and it is an object of the present invention to provide a nasal and maxillary growth enhancer, which can enhance the correct efficiency and provide an effect of deformity correction since it promote nasal and maxillary growth by retracting the nose and lips together with the maxillaries during a correction treatment of the Class III malocclusion.

To accomplish the above object, according to the present invention, there is provided a nasal and maxillary growth enhancer, which can promote nasal, labial and maxillary growth by simultaneously retracting the nose, lips and maxillaries after a nose retracting member and a lip retracting member are elastically connected to a face mask, which is a maxillary protraction appliance (MPA) used for a correction of the Class III malocclusion.

As described above, the nasal and maxillary growth enhancer according to the present invention can correct the Class III malocclusion, which is called a ‘jutting chin’, and provide an effect of deformity correction by promoting the nasal and labial growth without undergoing a plastic surgery.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1a to 1d are views showing general face masks of various kinds;

FIGS. 2a and 2b are views showing maxillary expanders of various kinds, each of which is used in the oral cavity together with a face mask;

FIG. 3 is a perspective view of a nose retracting member of a nasal and maxillary growth enhancer according to the present invention;

FIGS. 4a and 4b are enlarged sectional views of length adjusting means of the nose retracting member according to the present invention;

FIG. 5 is a perspective view of a nose retracting member and a lip retracting member according to another preferred embodiment of the present invention; and

FIG. 6 is a view showing a used state of the nasal and maxillary growth enhancer according to the present invention.

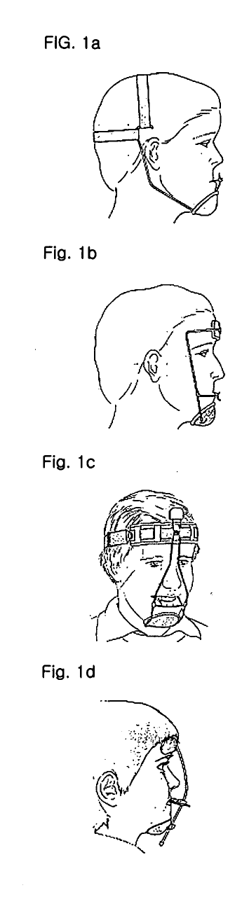

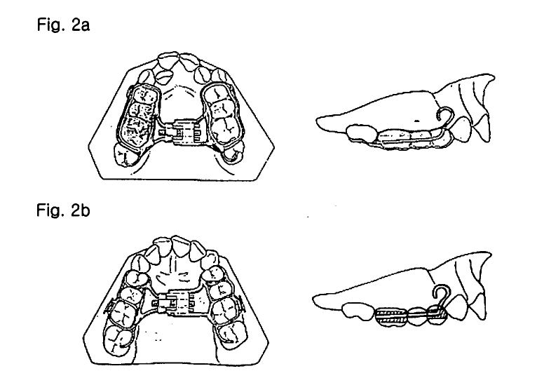

### DETAILED DESCRIPTION OF THE PREFERRED EMBODIMENT

Reference will be now made in detail to the preferred embodiment of the present invention with reference to the attached drawings.

A nasal and maxillary growth enhancer 1 according to the present invention includes a face mask 2, which is a general maxillary protraction appliance, and a nose retracting member 3 elastically connected to the face mask 2.

Since the face mask 2 is the maxillary protraction appliance, which is now widely used in dental clinics and hospitals, its detailed description will be omitted.

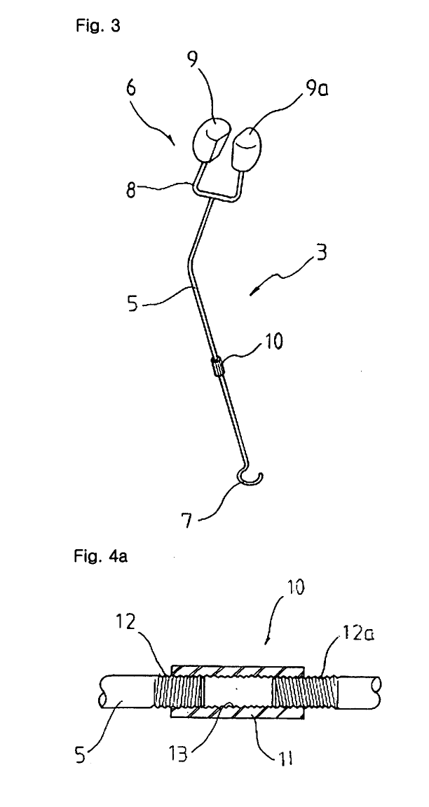

As shown in FIG. 3, the nose retracting member 3 includes: a connected 5 having an inclined upper portion; a nose grip 6 formed on the top of the connector 5; and a hook 7 formed on the bottom of the connector 5, the hook 7 being directly connected to a stick or a hook, which is vertically connected to a head cap or a chin cup of the face mask to provide a traction power, or being connected to the stick or hook via an elastic member, such as a rubber ring.

The nose grip 6 formed on the top of the connector 5 of the nose retracting member 3 includes: elastic arms 8 branched from the top of the connector 5 into two parts and inclined inwardly; and nasal septum holders 9 and 9a respectively formed on ends of the elastic arms 8 to hold the nasal septum (located on the centerline between the two nostrils) after being inserted into the nostrils, the nasal septum holders 9 and 9a being made of a material, which is harmless to people, such as silicon. Moreover, each of the nasal septum holders 9 and 9a has a flat inner surface, and hence, the nose grip 6 can strongly hold the nose (nasal septum)

In addition, the nose retracting member 3 includes length adjusting means 10 mounted on a lower portion of the connector 5 in such a way as to adjust a distance between the nose and the mouth since the distance between the nose and the mouth is varied according to patients' ages and sexes.

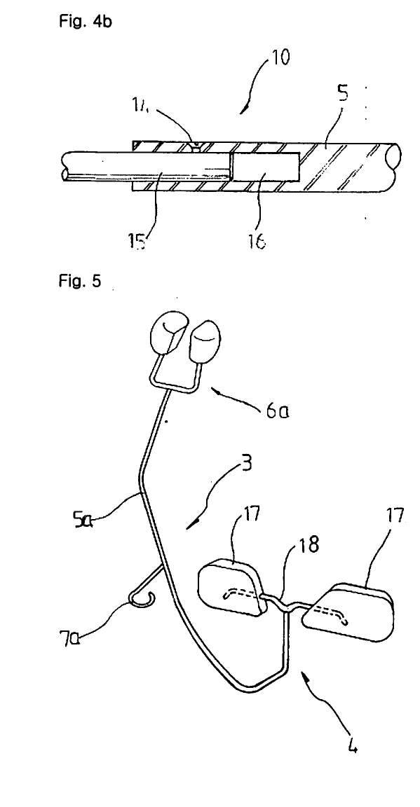

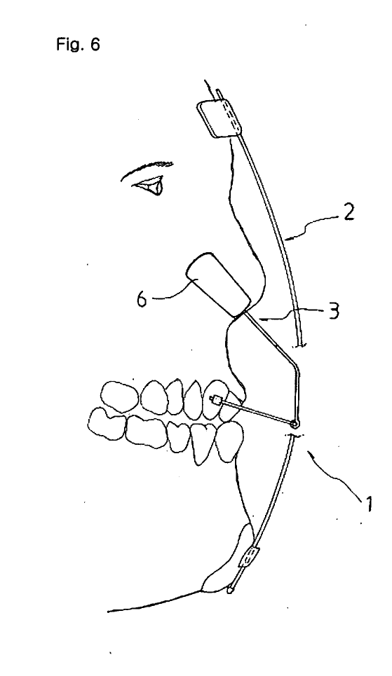

In order to adjust the length of the nose retracting member 3, as shown in FIG. 4a, the length adjusting means 10 includes: two shaft bars formed in such a way that a lower portion of the connector 5 is separated into two parts; male screws 12 and 12a formed at end portions of the shafts; and a length adjuster 11 having a female screw 13 and screw-coupled with the shafts. Alternatively, as shown in FIG. 4b, the length adjusting means 10 includes: a shaft bar 15 separated from the lower portion of the connector 5; a slide hole 16 formed in the connector 5 for inserting the shaft bar 15 thereinto; and a screw 14 mounted for fixing the shaft bar 15 to the slide hole 16.

As described above, a position of the hook 7 is adjusted in such a way as to be fit to the distance between the nose and the mouth using the length adjusting means 10 formed on the lower portion of the nose retracting member 3, and then, the elastic arms 8 of the nose grip 6 formed on the top of the connector 5 are opened wide so that the nasal septum holders 9 and 9a can fit and hold the nasal septum. In this above state, the hook 7 formed on the bottom of the connector 5 is vertically connected to the head cap and the chin cup of the face mask 2, which is the maxillary protraction appliance, and then, directly connected to the stick or hook for providing the traction power or connected to the stick or hook via the elastic member, such as the rubber ring, whereby the nasal and maxillary growth enhancer 1 can retract the anterior maxillary bone and draw the nose forward to promote the nasal growth while power is applied to the anterior maxillary bone.

Furthermore, in another preferred embodiment of the present invention, as shown in FIG. 5, the nasal and maxillary growth enhancer according to the present invention includes: a nose retracting member 3 having a nose grip 6a; a lip retracting member 4 having two lip pads 17 and a support wire 18 for supporting the lip pads 17; a connector 5a having an inclined upper portion and a curved lower portion, the connector 5a being adapted to connect the nose retracting member 3 and the lip retracting member 4 with each other; and a hook 7a formed on the connector 5a and connected with the face mask 2, so that the nasal and maxillary growth enhancer can retract the nose, lips and maxillary bone simultaneously to thereby promote nasal, labial and maxillary growth.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A nasal and maxillary growth enhancer comprising:
a nose retracting member connected with a face mask, which is a maxillary protraction appliance, to be provided with an anterior traction power, the nose retracting member comprising:
a nose grip having elastic arms branched from the top of a connector into two parts and inclined inwardly and nasal septum holders respectively formed on ends of the elastic arms to hold the nasal septum, located on the centerline between the two nostrils, after being inserted into the nostrils;
the connector adapted to support the nose grip and a hook; and
the hook formed on the bottom of the connector (5).

2. The nasal and maxillary growth enhancer according to claim 1, wherein the nose retracting member comprises length adjusting means formed on a lower portion of the connector in such a way as to adjust a distance between the nose and the mouth since the distance between the nose and the mouth is varied according to patients' ages and sexes.

3. The nasal and maxillary growth enhancer according to claim 1, wherein the nasal and maxillary growth enhancer comprises:
a nose retracting member having a nose grip;
a lip retracting member having two lip pads and a support wire for supporting the lip pads;
a connector having an inclined upper portion and a curved lower portion, the connector being adapted to connect the nose retracting member and the lip retracting member with each other; and
a hook formed on the connector and connected with the face mask, so that the nasal and maxillary growth enhancer can retract the nose, lips and maxillary bone simultaneously to thereby promote nasal, labial and maxillary growth.
